(19) United States
(12) Patent Application Publication
(10) Pub. No.: US 2018/0317537 A1
(43) Pub. Date: Nov. 8, 2018

(54) Soluble Fiber Liquid Beverage Concentrate and Method for Delivery of Soluble Fiber

(71) Applicant: MOBERG PHARMA AB, Bromma (SE)

(72) Inventors: Joe Knutzen, Allendale, NJ (US); James D. Hammer, Uxbridge, MA (US); Bryan Duke, New York, NY (US)

(21) Appl. No.: 15/772,459

(22) PCT Filed: Oct. 28, 2016
(86) PCT No.: PCT/GB2016/053361

§ 371 Date: Apr. 30, 2018

Related U.S. Application Data
(63) Continuation-in-part of application No. 15/143,674, filed on May 2, 2016.
(60) Provisional application No. 62/249,000, filed on Oct. 30, 2015.

(51) Int. Cl. A23L 33/21; A23L 2/56; A23L 2/68; A23L 2/60; A23L 2/44; A23L 2/46; A23L 2/385

(52) U.S. Cl. CPC A23L 33/21; A23L 2/56; A23L 2/68; A23V 2002/00; A23L 2/44; A23L 2/46; A23L 2/385; A23L 2/60

(57) ABSTRACT

A flavored, fiber-enriched liquid beverage concentrate of an acidulant, a flavor, a high-intensity sweetener, a soluble fiber, and water, the soluble fiber comprising about 20 to 60 percent by weight of the concentrate volume with a pH in a range of about 1.2 to about 4.0. A method of delivering soluble fiber from a liquid beverage concentrate is disclosed.

### TECHNICAL FIELD

The present invention relates to edible products and methods for providing soluble fibers to persons as a nutritional supplement. More particularly, the present invention relates to soluble fiber (especially soluble dietary fiber) liquid beverage concentrates and methods for delivery of soluble fibers for nutritional supplements for persons.

### BACKGROUND OF THE PRESENT INVENTION

Edible fibers are one of many important food components that contribute to healthy physiological biometrics of youths and adults. Such fibers contribute to the nutritional processing and digestion of foods and to the elimination of solid wastes from foods. Edible fibers found in foods are of a soluble type and an insoluble type. Soluble fibers attract and absorb water. Soluble fibers absorb water while passing through a person's gastrointestinal tract including the stomach and intestines. This effects a reduction in the digestion process of foods, delays emptying of the stomach, and contributes to a sense that one is full while eating foods. As a result, a person feeling full may eat less and this helps control weight gain. Soluble fibers within a lower intestinal tract also contribute to consistency of stool formation and elimination. Suitable amounts of dietary soluble fibers have smoothing or balancing effects on bowel actions of a person by reducing by both constipation and diarrhea in waste elimination functions. These problems of stools being excessively dense or excessively fluid are referenced generally as irritable bowel syndrome. Further, soluble fiber within a dietary regime is considered as having favorable effects on blood sugar levels, insulin sensitivity and LDL cholesterol.

In 2006, and subsequently available annually, the National Academy of Sciences, Institute of Medicine promulgated suggested dietary intakes in a guide to nutrient requirements. The Institute recommends that male adults (over age 14 and less than age 50) consume about 38 g/day of total dietary fiber comprising both soluble and insoluble fibers; the recommendation for female adults is about 25 g/day total dietary fiber. For younger male children (over age 1), the recommendation ranged from about 19 g/day total dietary fiber, over age 4 at about 25 g/day total dietary fiber, and over age 9, about 31 g/day total dietary fiber. For younger female children (over age 1), the recommendation ranged from about 19 g/day total dietary fiber and over age 4 at about 25 g/day total dietary fiber. However, reports suggest that many persons consume less than half of the recommended dietary fibers.

Accordingly, there is a need in the art for an edible food containing soluble fibers and a method of delivering soluble fibers to persons as a nutritional supplement. It is to such that the present invention is directed.

### SUMMARY OF THE PRESENT INVENTION

The present invention meets the need in the art by providing a flavored, fiber-enriched liquid beverage concentrate, comprising an acidulant, a flavor, a high-intensity sweetener, a soluble fiber, and water, the soluble fiber comprising about 20 to 60 percent by weight of the concentrate volume with a pH in a range of about 1.2 to about 4.0.

In another aspect, there is provided a flavored, fiber-enriched liquid beverage concentrate, comprising an acidulant, a flavor, a high-intensity sweetener, a dietary fiber (e.g. soluble dietary fiber), and water, the dietary fiber (e.g. soluble dietary fiber) comprising about 20 to 60 percent by weight of the concentrate volume with a pH in a range of about 1.2 to about 4.0.

In a further aspect, there is provided a flavored, fiber-enriched liquid beverage concentrate, comprising an acidulant, a flavor, a high-intensity sweetener, a soluble fiber (e.g. soluble dietary fiber), a preservative and water, the soluble fiber (e.g. soluble dietary fiber) comprising about 20 to 60 percent by weight of the concentrate volume with a pH in a range of about 1.2 to about 6.5.

In a further aspect, there is provided a flavored, fiber-enriched liquid beverage concentrate, comprising an acidulant, a flavor, a high-intensity sweetener, a dietary fiber (e.g. soluble dietary fiber), a preservative and water, the dietary fiber (e.g. soluble dietary fiber) comprising about 20 to 60 percent by weight of the concentrate volume with a pH in a range of about 1.2 to about 6.5.

In another aspect, the present invention provides a method of delivering a soluble fiber (e.g. soluble dietary fiber) for human consumption, comprising the steps of:

(a) providing a beverage concentrate comprising an acidulant, a flavor, a high-intensity sweetener, a soluble fiber (e.g. soluble dietary fiber), and water, the soluble fiber (e.g. soluble dietary fiber) comprising about 20 to 60 percent by weight of the concentrate volume with a pH in a range of about 1.2 to about 4.0; and

(b) admixing the beverage concentrate with water to a volume in a range of about 4 ounces to about 16 ounces.

In another aspect, the present invention provides a method of delivering a dietary fiber (e.g. soluble dietary fiber) for human consumption, comprising the steps of:

(a) providing a beverage concentrate comprising an acidulant, a flavor, a high-intensity sweetener, a dietary fiber (e.g. soluble dietary fiber), and water, the dietary fiber (e.g. soluble dietary fiber) comprising about 20 to 60 percent by weight of the concentrate volume with a pH in a range of about 1.2 to about 4.0; and

(b) admixing the beverage concentrate with water to a volume in a range of about 4 ounces to about 16 ounces.

The typical amount of the beverage concentrate that is used per serving is from 5 mL to 10 mL.

Objects, advantages, and features of the present invention may be readily determined upon a reading of the detailed description in conjunction with the drawings and the appended claims.

### DETAILED DESCRIPTION

The present invention provides a flavored, fiber-enriched liquid beverage concentrate, comprising an acidulant, a flavor, a high-intensity sweetener, a soluble fiber (e.g. soluble dietary fiber), and water, the soluble fiber (e.g. soluble dietary fiber) comprising about 20 to 60 percent by weight of the concentrate volume with a pH in a range of about 1.2 to about 4.0.

In an alternative aspect, there is provided a flavored, fiber-enriched liquid beverage concentrate, comprising an acidulant, a flavor, a high-intensity sweetener, a dietary fiber (e.g. soluble dietary fiber), and water, the dietary fiber (e.g. soluble dietary fiber) comprising about 20 to 60 percent by weight of the concentrate volume with a pH in a range of about 1.2 to about 4.0.

The term “fiber-enriched” (e.g. fiber-enriched liquid beverage concentrate) refers to a high fiber product that may be used as a nutritional supplement to increase a person's intake of fiber (e.g. dietary fiber).

The term “liquid beverage concentrate” refers to a liquid product that may be diluted with drinking water in order to produce a beverage suitable for human consumption.

Preparation of the liquid concentrate involves mixing of the water carrier with the constituents, for example, in sequence of a preservative (if any), the sweetener, the soluble fiber (e.g. soluble dietary fiber), the flavoring, coloring (if any), and the acidulant.

In another aspect, preparation of the liquid concentrate involves mixing of the water carrier with the constituents, for example, in sequence of a preservative (if any), the sweetener, the dietary fiber, the flavoring, coloring (if any), and the acidulant.

A packaging for the liquid concentrate preferably contains a plurality of servings although the liquid concentrate may in an alternate embodiment be provided in a single-serving package.

The packaging dispenses a serving amount for dilution in added water content. A serving amount of the illustrated embodiments is about 7 to 11 grams or about 1.5 teaspoons, preferably about 9.5 grams, and delivering about 2.5 grams to about 4 grams soluble fiber (e.g. soluble dietary fiber), preferably about 3 grams of soluble fiber (e.g. soluble dietary fiber).

In certain embodiments, a serving amount is about 7 to about 11 grams or about 1.5 teaspoons, preferably about 9.5 grams, and delivering about 2.5 grams to about 4 grams dietary fiber (e.g. soluble dietary fiber), preferably about 3 grams of dietary fiber (e.g. soluble dietary fiber).

Dietary fibers are non-digestible carbohydrates in the diet that, when consumed, pass through the small intestine into the large intestine where they may be partially or completely fermented by colonic microbiotica. Dietary fibers typically include non-digestible soluble and insoluble carbohydrates (with 3 or more monomeric units), and lignin that are intrinsic and intact in plants. Examples of such carbohydrates include, but are not limited to, β-glucan soluble fiber, psyllium husk, cellulose, guar gum, pectin, locust bean gum, and hydroxypropylmethylcellulose.

In a preferred embodiment, the soluble fiber is dietary fiber.

In a further preferred embodiment, the soluble and/or dietary fiber (e.g. soluble dietary fiber) is soluble corn fiber (for example PROMITOR® Soluble Corn Fiber 70L).

Soluble fibers and/or dietary fibers (e.g. soluble dietary fibers) useful with embodiments of the present invention include vegetable fibers of types that desirably solubilize completely in water, under normal conditions, to yield a clear to almost clear liquid product, as well as fruit fiber, grain fibers, water-swellable fibers including galactomannan and hydrocolloids, natural soluble fibers and synthetic soluble fibers that solubilize to yield the desirable clear liquid product.

As used herein, the term “solubilize completely in water” may be understood to refer to the solubility properties of a substance (e.g. a type of fiber) in water. Substances that “solubilize completely in water” produce a uniform solution or suspension, wherein at least about 50% of the substance is dissolved in (i.e. molecularly dispersed within) the solution, such as at least about 60%, for example at least about 70% (e.g. at least about 80%).

As used herein, the phrase “normal conditions” may be understood to indicate that the specified parameter (e.g. solubility) is determined at ambient temperature (e.g. about 25° C.) and at atmospheric pressure.

Vegetable sources having appropriate fiber properties include pea, carrot, soy and potato, as well as microcrystalline cellulose.

Fruit sources having soluble fibers and/or dietary fibers (e.g. soluble dietary fibers) include apple, tomato and berries. A natural hydrocolloid pectin provides a soluble fiber and/or dietary fiber (e.g. soluble dietary fiber) source.

While grain fibers are primarily insoluble, some grain fibers have satisfactory properties for use with the liquid beverage concentrate of the present invention. Grain fibers could also be processed to improve solubility. Such processing may comprise heating and/or chemical treatment (e.g. acid treatment). For example, soluble corn fiber is obtained through the acidic hydrolysis of corn starch and subsequent cooling, during which a mixture of β-glycosidic linkages are formed. These β-glycosidic linkages are resistant to mammalian enzymatic hydrolysis. These grain fibers include oat, wheat, oat bran, barley and corn. Soluble corn fiber may also be obtained by isolating an oligosaccharide-rich fraction from corn syrup.

Galactomannan and hydrocolloids water-swellable fibers useful with the present invention include pectin, guar, carrageenan, tragacanth, alginate, konjac and psyllium. Synthetic water-swellable fibers include carboxymethylcellulose, methylcellulose, hydroxpropylmethylcellulose, and hydroxypropylcellulose.

Natural fibers that solubilize and yield a clear liquid include Soluble Corn Fiber, maltodextrin and acacia, and particularly acacia prepared as a low viscosity hydrocolloid, and hydrolyzed guar gum.

Synthetic soluble fibers include polydextrose, modified food starch, and similar.

More particularly, food grade sources of soluble fiber and/or dietary fiber (e.g. soluble dietary fiber) useful in embodiments of the present invention include corn fiber, barley, corn germ, ground oat hulls, milled corn bran, derivatives of the aleurone layer of wheat bran, flax flour, whole flaxseed bran, milled flaxseed bran, winter barley flake, ground course kilned oat groats, maize, pea fiber (e.g. Canadian yellow pea) Danish potatoes, konjac vegetable fiber, psylliumfiber from seed husks of planago ovate, psyllium husk, liquid agave fiber, rice bran, oat sprout fibers, amaranth sprout, lentil flour, grape seed fiber resulting from fine milling, apple, blueberry, cranberry, fig fibers, ciranda power, carob powder, milled prune fiber, mixed mango and apple fiber, orange, orange pulp, strawberry, carrageenan hydrocolloid, derivatives of eucheuma cottonnil seaweed, cottonseed, soya, kiwi, acacia gum fiber, bamboo, chia, potato, potato starch, pectin (carbohydrate) fiber, hydrolyzed guar gum, carrot, soy, soybean, oat, wheat, tomato, polydextrose fiber, refined corn starch syrup, multi-fruit seed blends, isomalto-oligosaccharide mixtures, dehulled seeds of pulse crops, soluble dextrin derived from corn starch, course hemp powder, mixtures of citrus bioflavonoids, mixtures of citrus bioflavonoids comprising mainly hesperidin, mixtures of citrus bioflavonoids and dietetic fibers such as orange, grapefruit or lemon, cell-wall broken nutritional yeast, lipophilic fibers, plum juice, derivatives from larch trees, highly branched polysaccharide, highly branched polysaccharide composed of galactose and arabinose, highly branched polysaccharide composed of galactose, arabinose and polyphenols, yeast from saccharomyces cerevisiae, olygose fibers, derivatives from cane sugar, short-chain fructooligosaccharides, synthetic polymers of glucose, polydextrose, pectin, polanion compounds, natural 5-carbon sugars, cellulose fibers, cellulose fibers derived from hard wood plants, carboxymethyl cellulose, and fat replacement products.

It is to be appreciated that some of the foregoing sources of soluble fiber and/or dietary fiber (e.g. soluble dietary fiber) include both soluble and insoluble components. It is expected that sources with relatively higher amounts of insoluble components are less desirable for the fiber-enriched liquid beverage concentrate of the present invention, and such sources may require separate processing for extraction and/or separation of the insoluble components for use of the source for soluble fibers in the beverage concentrate.

In certain embodiments, the soluble fiber and/or dietary fiber (e.g. soluble dietary fiber) contains more than about 50% (by weight) soluble fiber, such as more than about 60% (by weight) soluble fiber, for example more that about 70% (by weight) soluble fiber (e.g. more than about 80% (by weight) soluble fiber).

Suitable fiber sources useful with embodiments of the present invention are of types providing application characteristics and properties of a combination of high fiber content, high solubility with low viscosity, low flavor impact, low pH tolerance. Other desirable characteristics include sources that are readily available from a range of reliable providers and relatively low comparative costs. Suitable fiber sources include natural fiber sources and synthetic fiber sources. The fiber source may be individual, or may be combinations of soluble fibers and/or dietary fiber (e.g. soluble dietary fiber). Individual fiber sources having favorable solubility properties are favored and include Soluble Corn Fiber and polydextrose. Other less soluble-favorable sources include acacia, dextrin, hydrolyzed gar, and modified starch. These latter sources readily combine with the more favorable solubility sources to modify physical properties of the embodiments as may be selectively desired. Fiber source combinations include for example, soluble corn fiber with polydextrose, soluble corn fiber with acacia, soluble corn fiber with dextrin, soluble corn fiber with hydrolyzed gar, and soluble corn fiber with modified starch; polydextrose with acacia, polydextrose with dextrin, polydextrose with hydrolyzed gar, and polydextrose with modified starch, as well as polydextrose with soluble corn fiber.

Preferred sources of soluble and/or dietary fiber include soluble corn fiber (such as PROMITOR® Soluble Corn Fiber 70L, which contains at least 70% (by weight) fiber (50.4% (by weight) dietary fiber), and polydextrose (such as STA-LITE® 370 Polydextrose, which contains at least 52.5% (by weight) dietary fiber).

In preferred embodiments the soluble and/or dietary fiber (e.g. soluble dietary fiber) comprises or consists of soluble corn fiber, polydextrose or combinations thereof. In more particular embodiments the soluble and/or dietary fiber (e.g. soluble dietary fiber) comprises or consists of soluble corn fiber.

A preservative may optionally be mixed with the liquid beverage concentrate depending upon the particular soluble fiber. Acid hydrolysis reduces some fiber sources to simpler carbohydrate and thus reduce the effective activity of the soluble fiber. Such reduction may in alternate embodiments be mitigated by buffering the pH of the concentrate at 4.5 or higher. Suitable preservatives include sodium benzoate, potassium sorbate, polylysine, propylene glycol, and methylparaben.

According to a further aspect of the invention, there is provided a flavored, fiber-enriched liquid beverage concentrate, comprising an acidulant, a flavor, a high-intensity sweetener, a soluble fiber (e.g. soluble dietary fiber), a preservative and water, the soluble fiber (e.g. soluble dietary fiber) comprising about 20 to 60 percent by weight of the concentrate volume with a pH in a range of about 1.2 to about 6.5.

In a further particular embodiment of this aspect of the invention, there is provided a flavored, fiber-enriched liquid beverage concentrate, comprising an acidulant, a flavor, a high-intensity sweetener, a dietary fiber (e.g. soluble dietary fiber), a preservative and water, the dietary fiber (e.g. soluble dietary fiber) comprising about 20 to 60 percent by weight of the concentrate volume with a pH in a range of about 1.2 to about 6.5.

In particular embodiments for all of the aspects of the invention, the preservative may be present in amounts of from about 0.01% w/w to about 0.30% w/w (relative to the beverage concentrate), such as from about 0.02% w/w to about 0.25% w/w, for example from about 0.05% w/w to about 0.20% w/w (e.g. from about 0.05% w/w to about 0.15% w/w).

Sodium benzoate may be useful in formulations having a low pH, such as about 4.5 and below, preferably about 2.5-4.0 pH, but preferably used in low concentrations of about 0.1% to 0.2% w/w, while providing activity spectrum against yeasts, molds and bacteria.

Potassium sorbate may be useful in formulations of higher pH, such as 6.5 and below, and provides good water solubility but may be unstable at elevated temperatures (38° C.) or in strong light, with an activity spectrum against molds and yeasts primarily.

Polylysine may be useful in high temperature, high pH products with a broad spectrum antimicrobial activity that results from a strong cationic charge, and readily dissolves in water with minimal effect on taste and odor. Polylysine may work synergistically with other preservatives while providing temperature differences stability and pH tolerance across a range from weak acidic to weak alkaline.

Propylene glycol provides activity against bacteria and fungi, and while miscible with water, required higher levels of use concentration.

Methylparaben provides an activity spectrum against fungi and gram-positive bacteria but relatively poor activity against pseudomonads. While having broad pH range, methylparaben is poorly water soluble and is incompatible with nonionic and cationic surfactants.

Alternatively, reduced preservative content may be obtained through mechanical actions including controlled water activity, pasteurization and heat processing, and pH control. Controlled water activity may be attained with high concentration of fiber or other dissolved solids that reduce water activity. High temperature processing and pasteurization of the concentrate may be appropriate for tolerant fiber sources. Low pH of particular preferred embodiments provides a tart flavor upon dilution and may assist with preventing or inhibiting microbial growth.

In particular embodiments, suitable pH values for the formulations are in the range of from about 1.2 to about 4.0, such as from about 1.2 to about 3.5, for example from about 1.2. to about 2.5 or from about 1.2 to about 2.0, preferably from about 1.2 to about 1.8 (e.g. from about 1.3. to about 1.6).

In further embodiments, the pH values for the formulations are in the range of about 1.5 to about 3.5, such as from about 1.5 to about 3.0, for example from about 1.5 to about 2.5 (e.g. from about 1.5 to about 2.0).

In embodiments in which the beverage concentrate comprises a preservative, the pH values may be in the range of from about 1.2 to about 6.5, such as from about 1.2 to about 5.5, for example from about 1.2 to about 4.5 (e.g from about 2.0 to about 6.0, from about 2.5 to about 5.0, or from about 3.0 to about 4.5).

It is to be further appreciated that a high concentration of soluble fiber or dietary fiber (e.g. soluble dietary fiber) and solids reduces water activity and reduces a need for a discrete preservative. Further, container materials may provide a preservative effect on contents.

An alternate embodiment may include a stabilizer, such as alpha-cyclodextrin or gum acacia.

An alternate embodiment may include a binder, such as amorphophallus propol plant fibers and/or emulsifiers.

Compositions useful in accordance with the present invention may be prepared in liquid beverage concentrates for dilution in a supply of drinking water of between about 4 and 16 ounces of water, preferable about 8 ounces of drinking water. The concentrated compositions are provided in an aqueous carrier of a volume of between about 5 and 10 ml per dose for mixing in the diluent water for consumption.

Table 1 presents representative examples of the flavored, fiber-enriched, liquid beverage concentrate composition of the present invention.

TABLE 1

| | Example 1 | Example 2 | Example 3 | Example 4 |
|---|---|---|---|---|
| Ingredient | Amount (grams) | | | |
| Soluble fiber | 3.00 | 3.00 | 2.50 | 2.50 |
| Preservative | 0.01 | 0.01 | 0.01 | 0.01 |
| Acidulant | 0.30 | 0.20 | 0.30 | 0.23 |
| Sweetener | 0.22 | 0.11 | 0.22 | 0.10 |
| Flavor | qs | qs | qs | qs |
| Color | qs | qs | qs | qs |
| Water | <1.48 | <1.68 | <1.97 | <2.16 |
| Total | 5.00 | 5.00 | 5.00 | 5.00 |

Fiber-enriched, liquid beverage concentrate compositions consistent with Examples 1-4 were evaluated:

| Fiber Source | Results |
|---|---|
| Soluble corn fiber-1 | Clear, stable, low flavor impact |
| Polydextrose-1 | Clear, stable, low flavor impact |
| Soluble corn fiber with polydextrose | Clear, stable, low flavor impact |
| Soluble corn fiber with acacia | Slight haze initially, falls out |
| | after 4 days |
| Soluble corn fiber with dextrin | Hazy |
| Soluble corn fiber with hydrolyzed guar | Hazy |
| Soluble corn fiber with modified starch | Hazy |
| Polydextrose with acacia | Clear initially, falls out after |
| | 24 hours |
| Polydextrose with dextrin | Hazy |
| Polydextrose with hydrolyzed guar | Hazy |
| Polydextrose with modified starch | Hazy |
| Soluble corn fiber-1 | Clear, stable, low flavor impact |
| Polydextrose-1 | Clear, stable, low flavor impact |

Example 5 in Table 2 below provides a base formulation that modifies Example 1 to provide a lower fiber percentage for the fiber-enriched, liquid beverage concentrate composition.

TABLE 2
Example 5

| | | | Composition | |
|---|---|---|---|---|
| | Amount | Amount | (diluted to 12 oz. | Amount (% |
| Ingredient | (% w/w) | (grams) | (350 g)) | as diluted) |
| Soluble fiber | 50.00 | 2.50 | 2.50 | 0.714 |
| Preservative | 0.20 | 0.01 | 0.01 | 0.003 |
| Acidulant | 4.60 | 0.23 | 0.23 | 0.065 |
| Sweetener | 2.00 | 0.10 | 0.10 | 0.029 |
| Flavor | qs | qs | qs | |
| Color | qs | qs | qs | |
| Water | 43.20 | 2.16 | 2.16 | 0.617 |
| Added Water | | | 345.00 | 98.571 |
| Total | 100.00 | 5.00 | 350.00 | 100.00 |

Fiber-enriched, liquid beverage concentrate compositions according to Example 5 may use citric acid as the acidulant which allows adjusting the pH into a range of about 2.0 to about 3.0. Potassium sorbate may be added to protect from microbial growth.

TABLE 3
Example 6 described in Table 3 below provides a higher amount
of soluble fiber in the concentrate than that provided in the
embodiment of Example 5. The concentrate may include additional
water for viscosity flow of the concentrate from a container when
diluting with added water.
Example 6

| | | | Composition | |
|---|---|---|---|---|
| | Amount | Amount | (diluted to 12 oz | Amount (% |
| Ingredient | (% w/w) | (grams) | (350 g)) | as diluted) |
| Soluble fiber | 66.66 | 4.00 | 4.00 | 1.14 |
| Preservative | 0.17 | 0.01 | 0.01 | 0.003 |
| Acidulant | 3.83 | 0.23 | 0.23 | 0.065 |
| Sweetener | 1.67 | 0.10 | 0.10 | 0.029 |
| Flavor | qs | qs | qs | |
| Color | qs | qs | qs | |
| Water | 27.67 | 1.66 | 1.67 | 0.477 |
| Added Water | | | 344.00 | 98.286 |
| Total | 100.00 | 6.00 | 350.00 | 100.00 |

TABLE 4
These examples each provide an unflavored soluble fiber concentrate.

| | Example 7 | Example 8 |
|---|---|---|
| | Amount % | Amount % |
| Ingredient | (% w/w) | (% w/w) |
| Soluble Corn Fiber 70% | 75.00 | |
| (PROMITOR ® 70L | | |
| available from Tate & Lyle) | | |
| (dietary fiber) | (37.8) | |
| Polydextrose | | 75.00 |
| (STA-LITE ® 370 | | |
| polydextrose) | | |
| Potassium Sorbate, NF | 0.075 | 0.075 |
| Potassium Benzoate, NF | 0.20 | 0.20 |
| Citric Acid, anhydrous, USP | 1.00 | 1.00 |
| Water | 23.725 | 23.725 |
| Total | 100.00 | 100.00 |

The resulting fiber-enriched, liquid beverage concentrate yielded a uniform clear liquid having a light amber color and a visually slight viscosity and a pH of about 2.0 to 3.0, which concentrate dispersed quickly in a diluent water container with little or no mixing.

TABLE 5
Example 9 illustrates a black cherry flavored, fiber-enriched, liquid
beverage concentrate composition consistent with Example 6.
Example 9
Black Cherry Flavor

| | | | Composition | Amount |
|---|---|---|---|---|
| | Amount % | Amount | (diluted to 12 oz | (% |
| Ingredient | (w/w) | (grams) | (350 g)) | as diluted) |
| Soluble corn fiber | 63.54 | 3.177 | 3.177 | 0.908 |
| Black cherry flavor | 0.77 | 0.0385 | 0.0385 | 0.011 |
| Citric Acid | 5.00 | 0.250 | 0.250 | 0.071 |
| Coloring (w/v) | 2.84 | 0.142 | 0.142 | 0.041 |
| Sweetener | 0.49 | 0.0245 | 0.0245 | 0.007 |
| Water | 27.35 | 1.368 | 1.368 | 0.392 |
| Added Water | | | 345.00 | 98.57 |
| Total | 100.00 | 5.00 | 350.00 | 100.00 |

An alternate embodiment of Example 9 includes a preservative comprising potassium sorbate in an amount of 0.10 (w/w).

The resulting flavored fiber-enriched, liquid beverage concentrate in the alternate embodiment yielded a uniform transparent purple (dark reddish purple) liquid having a visually slight viscosity with a pH of about 1.43, which concentrate dispersed quickly in a diluent water container with little or no mixing. The concentrate tested to a Brookfield Viscosity (Spindle LV2@30 RPM@25° C.) of about 35 cps and a specific gravity of about 1.243.

TABLE 6
Example 10 provides an orange tangerine flavored, fiber-enriched,
liquid beverage concentrate composition that differs from Example 5
by changing the acidulant and sweetener to increase tartness.
Example 10
Orange Tangerine Flavor

| | | | Composition | |
|---|---|---|---|---|
| | Amount % | Amount | (diluted to 12 oz | Amount (% |
| Ingredient | (w/w) | (grams) | (350 g)) | as diluted) |
| Soluble corn fiber | 63.59 | 3.180 | 3.180 | 0.908 |
| Natural orange | 1.24 | 0.062 | 0.062 | 0.018 |
| tangerine flavor | | | | |
| Citric Acid | 6.00 | 0.300 | 0.300 | 0.085 |
| Coloring (w/v) | 1.48 | 0.075 | 0.075 | 0.021 |
| Sweetener | 0.46 | 0.023 | 0.023 | 0.007 |
| Water | 27.23 | 1.36 | 1.36 | 0.389 |
| Added Water | | | 345.00 | 98.57 |
| Total | 100.00 | 5.00 | 350.00 | 100.00 |

An alternate embodiment of Example 10 includes a preservative comprising potassium sorbate in an amount of 0.10 (w/w).

The resulting flavored fiber-enriched, liquid beverage concentrate in the alternate embodiment yielded a uniform translucent orange (medium) liquid having a visually slight viscosity and a pH of about 1.41, which concentrate dispersed quickly in a diluent water container with little or no mixing. The concentrate tested to a Brookfield Viscosity (Spindle LV2@30 RPM@25° C.) of about 35 cps and a specific gravity of about 1.245.

In an embodiment of the present invention, the beverage concentrate is a flavored, fiber-enriched liquid beverage concentrate formulated to contain a soluble fiber comprising about 20 to 60 percent by weight of the beverage concentrate with a pH in a range of about 1.2 to about 4.0, and further comprising an acidulant of citric acid in a range of from about 1% w/w to about 8% w/w (relative to the beverage concentrate), for example about 1% w/w to about 7% w/w (preferably about 2% w/w to about 6% w/w, and more preferably about 4% w/w to about 6% w/w) and further including a flavor and optionally a sweetener. In preferred embodiments, the sweetener is a high intensity sweetener, and is present in an amount of from about 0.1% w/w to about 2.0% w/w (relative to the beverage concentrate), such as from about 0.2% w/w to about 1.0% w/w, for example about 0.3% w/w to about 0.8% w/w (e.g. about 0.3% w/w to about 0.6% w/w).

In a further embodiment of the present invention, the beverage concentrate is a flavored, fiber-enriched liquid beverage concentrate formulated to contain a dietary fiber (e.g. soluble dietary fiber) comprising about 20 to 60 percent by weight of the beverage concentrate with a pH in a range of about 1.2 to about 4.0, and further comprising an acidulant of citric acid in a range of about from 1% w/w to about 8% w/w (relative to the beverage concentrate), for example about 1% w/w to about 7% w/w, preferably about 2% w/w to about 6% w/w, and more preferably about 4% w/w to about 6% w/w, and further including a flavor and optionally a sweetener. In preferred embodiments, the sweetener is a high intensity sweetener, and is present in an amount of from about 0.1% w/w to about 2.0% w/w, such as about 0.2% w/w to about 1.0% w/w, for example about 0.3% w/w to about 0.8% w/w (e.g. about 0.3% w/w to about 0.6% w/w).

TABLE 7
Example 11 provides an orange tangerine flavored, fiber-enriched,
liquid beverage concentrate composition.
Example 11

| | Amount % |
|---|---|
| Ingredient | (w/w) |
| PROMITOR 70L Soluble Corn Fiber | 66.67 |
| (dietary fiber) | (33.6) |
| Natural orange tangerine flavor | 1.08 |
| Citric Acid | 5.24 |
| Coloring (w/v) | 1.29 |
| Sweetener | 0.40 |
| Potassium Sorbate | 0.10 |
| Water | 25.22 |
| Total | 100.00 |

A 100 ml container of the flavored, fiber enriched, liquid beverage concentrate of Example 11 provides approximately 13.3 doses per container (7.5 ml per dose) with 3.16 grams soluble fiber per serving, when each serving is prepared in an 8 ounce diluent supply of drinking water.

Table 8 below provides ranges for the constituent ingredients of the flavored, fiber-enriched, liquid beverage concentrate composition in varying embodiments of the present invention. It is to be appreciated that the embodiments having a relatively higher concentration of soluble fiber dissolve in a smaller amount of diluent carrier water. While such embodiments may have increased viscosity, it is believed that the liquid beverage concentrate may nevertheless dispense from a container as a flowable stream under at least squeezing pressure applied by a user to the container. It is expected that embodiments with a relatively lower concentration of soluble fiber flow more readily as a stream from the container. The flavored, fiber-enriched, liquid beverage concentrate composition readily mixes with a supply of a diluent drinking water for consumption of the soluble fiber which supply is a volume selected as appropriate for the user. A supply of diluent drinking water may be such as carried in an exercise drinking bottle holding a reasonably drinkable quantity of water such as between about 4 ounces of water to about 16 ounces of water, preferably from about 4 ounces to about 12 ounces of water, more preferably between about 6 ounces of water to about 10 ounces of water, and preferably about 8 ounces of water, selectively by the user, while providing 2.00 to about 4.50 grams of soluble fiber and/or dietary fiber (e.g. soluble dietary fiber), preferably about 2.50 to about 3.50 grams of soluble fiber and/or dietary fiber (e.g. soluble dietary fiber), and more preferably about 2.50 to about 3.00 grams of soluble fiber and/or dietary fiber (e.g. soluble dietary fiber).

TABLE 8
Constitute Embodiments Of
Flavored, Fiber-Enriched, Liquid Beverage Concentrate Composition

| | Amount |
|---|---|
| Ingredient | (% w/w) |
| Soluble fiber | 20.00-60.00 |
| Preservative | 0.01-0.30 |
| Acidulant | 4.00-8.00 |
| Sweetener | 0.10-3.00 |
| Flavor | qs |
| Color | qs |
| Water | 28.70-75.89 |
| Total | 100.00 |

Generally, the constituents of the flavored, fiber-enriched, liquid beverage concentrate composition are added into the water sequentially as follows: preservative (if any), sweetener, soluble fiber (which contains dietary fiber), flavoring, coloring, and acidulant. The preparation procedure may be as follows:
charge the formulation quantity of water into a suitable mixing vessel;
add preservative (if any) and mix to dissolve;
add sweetener and mix to dissolve;
add flavoring and mix;
add coloring (if any) and mix;
add soluble fibers and mix until uniform;
add acidulant and mix until uniform and clear.

The acidulant, such as citric acid, is added after the other ingredients have been dissolved and the mixture is uniform.

The term “acidulant” refers to a chemical compound (or a mixture of compounds) that confers a tart, sour, or acidic flavor to food. Commonly-employed acidulants include citric acid, malic acid, lactic acid, lactic acid, phosphoric acid and tartaric acid. In particular embodiments the acidulant is citric acid, malic acid or a mixture thereof. In more particular embodiments the acidulant is citric acid.

In particular embodiments, the acidulant is present in a range of from about 1% w/w to about 8% w/w (relative to the beverage concentrate), for example about 1% w/w to about 7% w/w, preferably about 2% w/w to about 6% w/w, and more preferably about 4% w/w to about 6% w/w.

Early addition of the acidulant may cause poorly-soluble ingredients, such as benzoic acid or sorbic acid if present, to drop out of solution and re-dissolving may require application of heat.

The sweetener preferably is a low-calorie, high sweetness ingredient, such as a high-intensity sweetener.

The term “high-intensity sweetener” refers to sugar substitutes that are substantially sweeter than sugar (sucrose). High intensity sweeteners currently approved by the FDA include saccharin, aspartame, acesulfame potassium (Ace-K), sucralose, neotame, advantame, steviol glycosides and luo han guo fruit extracts.

Particular high intensity sweeteners that may be mentioned are shown below, along with their commonly-accepted potency figures.

| | Sweetness compared to | |
|---|---|---|
| Sweetener | sugar (sucrose) | |
| Cyclamate | 30 | times as sweet |
| Stevioside | 100-250 | times as sweet |
| Mogroside v | 100-300 | times as sweet |
| Rebaudioside a | 150-300 | times as sweet |
| Acesulfame-k | 200 | times as sweet |
| Aspartame | 200 | times as sweet |
| Saccharine | 300 | times as sweet |
| Neohesperidin dihydrochalcone | 300 | times as sweet |
| Sucralose | 600 | times as sweet |
| Neotame | 8000 | times as sweet |

In particular embodiments, the high-intensity sweetener is sucralose.

In preferred embodiments, the high intensity sweetener is present in an amount of from about 0.1% w/w (relative to the beverage concentrate) to about 3.0% w/w, for instance from about 0.1% w/w to about 2.0% w/w, such as from about 0.2% w/w to about 1.0% w/w, for example about 0.3% w/w to about 0.8% w/w (e.g. about 0.3% w/w to about 0.6% w/w).

While a sweetness/tartness profile available from compositions according to the present invention is broad, the fiber-enriched, liquid beverage concentrate may be diluted to about 8.0 fluid ounces +/− about 4.0 fluid ounces common to conventional water bottles associated with persons who participate in a variety of exercise regimes while maintaining an acceptable flavor profile during use of the composition. The skilled person will appreciate that the assessment of flavor is highly subjective and will vary to a large degree from person to person. In this context, the phrase “acceptable flavor profile” may be understood to refer to a range of flavors that are broadly considered palatable by a typical consumer. A starting point for sweetness targeting may be about 12° brix sugar solution at the 12 ounce dilution (one degree Brix is 1 gram of sucrose in 100 grams of solution and represents the strength of the solution as percentage by mass).

The fiber-enriched, liquid beverage concentrate according to the present invention provides soluble fiber as a nutritional supplement having a satisfactory mouthfeel while being readily dispensable as a flowable stream from a container with a visual viscosity yet dispersible in water to yield a uniform clear, transparent, or translucent dilution drinkable source of soluble fiber, and may readily be flavored for taste satisfaction. The fiber weight ranges from about 20% w/w to about 60% w/w, for example from about 30% w/w to about 60% w/w, such as from about 30% w/w to about 50% w/w, preferably about 26% w/w to about 43% w/w for example from about 30% w/w to about 40% w/w, while providing between about 2.5 grams soluble fiber per serving to about 4 grams soluble fiber per serving, preferably between about 2.5 and 3.5 grams soluble fiber per serving, and more preferably about 3.0 grams soluble fiber per serving, with a viscosity of the flavor enriched liquid beverage concentrate of about 10 cp to about 100 cp, in particular about 25 cp to about 85 cp, for example about 25 cp to about 75 cp, about 40 to about 70 cp, preferably about 30 cp to 50 cp, such as about 30 cp to about 40 cp, and more preferably about 30 cp to 35 cp (e.g. about 35 cp).

Viscosity may be measured using any suitable apparatus known to the skilled person, such as Brookfield Viscometer. The quoted values refer to those obtained using Spindle LV2 at 30 RPM and at a temperature of 25 ° C.

The dietary fiber weight in the beverage concentrate may range from about 20% w/w to about 60% w/w, for example from about 30% w/w to about 60% w/w, such as from about 30% w/w to about 50% w/w, preferably about 26% w/w to about 43% w/w for example from about 30% w/w to about 40% w/w, while providing between about 2.5 grams dietary fiber (e.g. soluble dietary fiber) per serving to about 4 grams dietary fiber (e.g. soluble dietary fiber) per serving, preferably between about 2.5 and 3.5 grams dietary fiber (e.g. soluble dietary fiber) per serving, and more preferably about 3.0 grams dietary fiber (e.g. soluble dietary fiber) per serving, with a viscosity of the flavor enriched liquid beverage concentrate of about 10 cp to about 100 cp, about 25 cp to about 85 cp, about 25 cp to about 75 cp, about 40 to about 70 cp, preferably about 30 cp to 50 cp, and more preferably about 30 cp to 35 cp (e.g. about 35 cp).

The compositions may be packaged for multiple serving doses or single serving dose. The compositions further are stable during ordinary storage and shipping of containers such that the soluble fibers remain in solution for a commercially practical period and in temperatures typically experienced for commercial nutritional products. In particular embodiments the flavored, fiber-enriched liquid beverage concentrate is provided as a packaged product comprising one or more servings (e.g. from 1 to 20 servings) as described hereinabove.

In certain embodiments, flavors that may be included in the formulations include fruit flavors (e.g. citrus fruits (orange, lemon, lime, grapefruit, tangerine, orange), berries (strawberry, raspberry, blueberry, cranberry), apple, pineapple, grape, cherry, and the like), botanical flavors (i.e. essential oils derived from natural sources e.g. cola flavoring and flavors derived from tea and coffee) and spices, and mixtures thereof. Preferred flavorings include natural fruit flavors (e.g. orange/tangerine flavor). The terms flavor and flavoring are used herein interchangeably.

In a particular embodiment, the flavored fiber-enriched liquid beverage concentrate comprises soluble fiber (e.g. soluble dietary fiber) in an amount of from about 20% w/w (relative to the beverage concentrate) to about 60% w/w and an acidulant in an amount of from about 1% w/w (relative to the beverage concentrate) to about 8% w/w, and has a pH in a range of from about 1.2 to about 4.0.

In a further particular embodiment, there is provided a flavored, fiber-enriched liquid beverage concentrate, comprising a soluble fiber (e.g. soluble dietary fiber) in an amount of about 20% w/w to about 60% w/w (relative to the beverage concentrate), an acidulant in an amount of from about 1% w/w to about 8% w/w (relative to the beverage concentrate) a preservative and water, with a pH in a range of from about 1.2 to about 6.5.

In a further particular embodiment, the flavored fiber-enriched liquid beverage concentrate comprises soluble fiber (e.g. soluble dietary fiber) in an amount of from about 30% w/w (relative to the beverage concentrate) to about 60% w/w and an acidulant in an amount of from about 4% w/w (relative to the beverage concentrate) to about 6% w/w, and has a pH in a range of from about 1.2 to about 3.0.

In a further particular embodiment, the flavored fiber-enriched liquid beverage concentrate comprises soluble fiber (e.g. soluble dietary fiber) in an amount of from about 30% w/w (relative to the beverage concentrate) to about 50% w/w and an acidulant in an amount of from about 4% w/w (relative to the beverage concentrate) to about 6% w/w, and has a pH in a range of from about 1.2 to about 2.0.

In a further particular embodiment, the flavored fiber-enriched liquid beverage concentrate comprises dietary fiber (e.g. soluble dietary fiber) in an amount of from about 20% w/w (relative to the beverage concentrate) to about 60% w/w and an acidulant in an amount of from about 1% w/w (relative to the beverage concentrate) to about 8% w/w, and has a pH in a range of from about 1.2 to about 4.0.

In a further particular embodiment, there is provided a flavored, fiber-enriched liquid beverage concentrate, comprising a dietary fiber (e.g. soluble dietary fiber) in an amount of about 20% w/w to about 60% w/w (relative to the beverage concentrate), an acidulant in an amount of from about 1% w/w to about 8% w/w (relative to the beverage concentrate) a preservative and water, with a pH in a range of from about 1.2 to about 6.5.

In a further particular embodiment, the flavoured fiber-enriched liquid beverage concentrate comprises dietary fiber (e.g. soluble dietary fiber) in an amount of from about 26% w/w (relative to the beverage concentrate) to about 43% w/w and an acidulant in an amount of from about 4% w/w (relative to the beverage concentrate) to about 6% w/w, and has a pH in a range of from about 1.2 to about 3.0.

In a further particular embodiment, the flavored fiber-enriched liquid beverage concentrate comprises dietary fiber (e.g. soluble dietary fiber) in an amount of from about 30% w/w (relative to the beverage concentrate) to about 40% w/w and an acidulant in an amount of from about 4% w/w (relative to the beverage concentrate) to about 6% w/w, and has a pH in a range of from about 1.2 to about 2.0.

Further particular embodiments of the invention are described in the following numbered paragraphs.

Paragraph 1. A flavored, fiber-enriched liquid beverage concentrate, comprising an acidulant, a flavor, a high-intensity sweetener, a dietary fiber, and water, the dietary fiber comprising about 20 to 60 percent by weight of the concentrate volume with a pH in a range of about 1.2 to about 4.0.

Paragraph 2. The beverage concentrate as recited in Paragraph 1, wherein the dietary fiber comprises about 50 per cent by weight of the concentrate volume.

Paragraph 3. The beverage concentrate as recited in Paragraph 1 or Paragraph 2, wherein the dietary fiber comprises about 33 per cent by weight of the concentrate volume.

Paragraph 4. The beverage concentrate as recited in any one of Paragraphs 1 to 3, wherein the concentrate volume is about 5 to 10 ml per serving.

Paragraph 5. The beverage concentrate as recited in any one of Paragraphs 1 to 4, wherein the acidulant comprises about 4 to about 8 per cent by weight of the concentrate volume.

Paragraph 6. The beverage concentrate as recited in any one of Paragraphs 1 to 5, wherein the acidulant comprises about 6 per cent by weight of the concentrate volume.

Paragraph 7. The beverage concentrate as recited in any one of Paragraphs 1 to 6, wherein the volume of the acidulant provides the beverage concentrate with a pH of about 1.5 to about 3.5.

Paragraph 8. The beverage concentrate as recited in any one of Paragraphs 1 to 7, wherein the volume of the acidulant provides the beverage concentrate with a pH of about 1.5.

Paragraph 9. The beverage concentrate as recited in any one of Paragraphs 1 to 8, wherein the dietary fiber comprises between about 2.5 and 4 grams by weight per serving of the beverage concentrate.

Paragraph 10. The beverage concentrate as recited in any one of Paragraphs 1 to 9, wherein the dietary fiber comprises about 3 grams by weight of the beverage concentrate.

Paragraph 11. The beverage concentrate as recited in any one of Paragraphs 1 to 10, wherein the dietary fiber is selected from the group comprising corn fiber (e.g. soluble corn fiber), polydextrose, and acacia.

Paragraph 12. The beverage concentrate as recited in any one of Paragraphs 1 to 11, wherein the dietary fiber comprises corn fiber.

Paragraph 13. The beverage concentrate as recited in any one of Paragraphs 1 to 12, further comprising a preservative.

Paragraph 14. The beverage concentrate as recited in Paragraph 13, wherein the preservative is selected from the group consisting of sodium benzoate, potassium sorbate, polylysine, propylene glycol, methylparaben, and mixtures thereof.

Paragraph 15. The beverage concentrate as recited in Paragraph 13 or Paragraph 14, wherein the preservative is about 0.01 to about 0.3 per cent by weight of the beverage concentrate.

Paragraph 16. The beverage concentrate as recited in any one of Paragraphs 13 to 15, wherein the preservative is about 0.1 per cent by weight of the beverage concentrate.

Paragraph 17. The beverage concentrate as recited in any one of Paragraphs 1 to 16, wherein the acidulant comprises citric acid.

Paragraph 18. The beverage concentrate as recited in any one of Paragraphs 1 to 17, wherein the concentrate has a viscosity of between about 25 and 70 cp (Brookfield Viscosity (Spindle LV2@30 RPM@25° C.)).

Paragraph 19. The beverage concentrate as recited in any one of Paragraphs 1 to 18, wherein the concentrate has a viscosity of about 30 cp (Brookfield Viscosity (Spindle LV2@30 RPM@25° C.)).

Paragraph 20. The beverage concentrate as recited in any one of Paragraphs 1 to 19, further comprising a buffering agent for adjusting the pH of the beverage concentrate to a selected pH in a range of between 1.2 pH and 4.0 pH.

Paragraph 21. The beverage concentrate as recited in any one of Paragraphs 1 to 20, wherein the soluble fiber comprises a mixture of a first fiber type and a second fiber type.

Paragraph 22. The beverage concentrate as recited in Paragraph 21, wherein the first fiber type comprises corn fiber (e.g. soluble corn fiber) and the second fiber type comprises dextrose.

Paragraph 23. A flavored, fiber-enriched liquid beverage concentrate, comprising an acidulant, a flavor, a high-intensity sweetener, a dietary fiber, a preservative and water, the dietary fiber comprising about 20 to 60 percent by weight of the concentrate volume with a pH in a range of about 1.2 to about 6.5.

Paragraph 24. The beverage concentrate as recited in Paragraph 23, wherein the preservative is selected from the group consisting of sodium benzoate, potassium sorbate, polylysine, propylene glycol, methylparaben, and mixtures thereof.

Paragraph 25. The beverage concentrate as recited in Paragraph 23 or Paragraph 24, wherein the preservative comprises about 0.01 to about 0.3 percent by weight of the beverage concentrate.

Paragraph 26. The beverage concentrate as recited in any one of Paragraphs 23 to 25, wherein the preservative comprises about 0.1 percent by weight of the beverage concentrate.

Paragraph 27. A method of delivering a soluble fiber for a nutritional supplement for persons, comprising the steps of:
(a) providing a beverage concentrate according to any one of Paragraphs 1 to 26; and
(b) admixing the beverage concentrate with water to a volume in a range of about 6 ounces to about 20 ounces.

Paragraph 28. The method as recited in Paragraph 27, wherein the volume is about 8 ounces.

Paragraph 29. The method as recited in Paragraph 27 or Paragraph 28, further comprising the step of pasteurizing of the beverage concentrate.

Paragraph 30. The method as recited in any one of Paragraph 27 to 29, further comprising the step of adjusting the pH of the beverage concentrate with a buffering agent to a selected pH in a range of between 1.2 pH and 4.0 pH.

Paragraph 31. The method as recited in any one of Paragraphs 27 to 30, further comprising the step of adjusting the viscosity of the beverage concentrate to a range between about 25 cp and 75 cp (Brookfield Viscosity (Spindle LV2@30 RPM@25° C.)).

Paragraph 32. The method as recited in any one of Paragraphs 27 to 31, further comprising the step of mixing as the dietary fiber a first fiber type and a second fiber type.

Paragraph 33. The method as recited in Paragraph 32, wherein the first fiber type comprises corn fiber (e.g. soluble corn fiber) and the second fiber type comprises dextrose.

Paragraph 34. The method as recited in any one of Paragraphs 27 to 33, wherein the dietary fiber comprises about 50 per cent by weight of the concentrate volume.

Paragraph 35. The method as recited in any one of Paragraphs 27 to 34, wherein the dietary fiber comprises about 33 per cent by weight of the concentrate volume.

While the invention is described in preceding detailed description with reference to specific exemplary embodiments thereof, it will be appreciated that various modifications and changes may be made thereto without departing from the broader spirit and scope of the invention as set forth in the appended claims. The specification is, accordingly, to be regarded as illustrative rather than restrictive.

Wherever the word “about” is employed herein (for example, in the context % amounts, pH ranges and viscosity values) it will be appreciated that such variables are approximate and as such may vary by ±10%, for example ±5% and preferably ±2% (e.g. ±1%) from the numbers specified herein.

The formulations described herein may have the advantage that they are higher in fiber than, of lower viscosity than, more palatable than, more convenient than and/or more stable to storage than high-fiber supplements known in the art (in the form of concentrated liquid formulations or otherwise). In particular, the formulations described herein provide a shelf-stable, high fiber product that is readily dispensible and/or disperses easily in water to form a palatable beverage.

1. A flavored, fiber-enriched liquid beverage concentrate, comprising an acidulant, a flavor, a high-intensity sweetener, a soluble fiber, and water, the soluble fiber comprising about 20 to 60 percent by weight of the concentrate volume with a pH in a range of about 1.2 to about 4.0.

2. The beverage concentrate as recited in claim 1, wherein the soluble fiber comprises about 50 per cent by weight of the concentrate volume.

3. The beverage concentrate as recited in claim 1, wherein the soluble fiber comprises about 33 per cent by weight of the concentrate volume.

4. The beverage concentrate as recited in claim 1, wherein the concentrate volume is about 5 to 10 ml.

5. The beverage concentrate as recited in claim 1, wherein the acidulant comprises about 4 to about 8 per cent by weight of the concentrate volume.

6. The beverage concentrate as recited in claim 1, wherein the acidulant comprises about 6 per cent by weight of the concentrate volume.

7. The beverage concentrate as recited in claim 1, wherein the volume of the acidulant provides the beverage concentrate with a pH of about 1.5 to about 3.5.

8. The beverage concentrate as recited in claim 1, wherein the volume of the acidulant provides the beverage concentrate with a pH of about 1.5.

9. The beverage concentrate as recited in claim 1, wherein the soluble fiber comprises between about 2.5 and 4 grams by weight per serving of the beverage concentrate.

10. The beverage concentrate as recited in claim 1, wherein the soluble fiber comprises about 3 grams by weight of the beverage concentrate.

11. The beverage concentrate as recited in claim 1, wherein the soluble fiber is selected from the group comprising corn fiber, polydextrose, and acacia.

12. The beverage concentrate as recited in claim 1, wherein the soluble fiber comprises corn fiber.

13. The beverage concentrate as recited in claim 1, further comprising a preservative.

14. The beverage concentrate as recited in claim 13, wherein the preservative is selected from the group consisting of sodium benzoate, potassium sorbate, polylysine, propylene glycol, methylparaben, and mixtures thereof.

15. The beverage concentrate as recited in claim 13, wherein the preservative is about 0.01 to about 0.3 per cent by weight of the beverage concentrate.

16. The beverage concentrate as recited in claim 13, wherein the preservative is about 0.1 per cent by weight of the beverage concentrate.

17. The beverage concentrate as recited in claim 1, wherein the acidulant comprises citric acid.

18. The beverage concentrate as recited in claim 1, wherein the concentrate has a viscosity of between about 25 and 70 cp (Brookfield Viscosity (Spindle LV2@30 RPM@25° C.)).

19. The beverage concentrate as recited in claim 1, further comprising a buffering agent for adjusting the pH of the beverage concentrate to a selected pH in a range of between 1.2 pH and 4.0 pH.

20. The beverage concentrate as recited in claim 1, further comprising a buffering agent for adjusting the pH of the beverage concentrate to a selected pH in a range of between 1.2 pH and 4.0 pH.

21. The beverage concentrate as recited in claim 1, wherein the soluble fiber comprises a mixture of a first fiber type and a second fiber type.

22. The beverage concentrate as recited in claim 21, wherein the first fiber type comprises corn fiber and the second fiber type comprises dextrose.

23. A flavored, fiber-enriched liquid beverage concentrate, comprising an acidulant, a flavor, a high-intensity sweetener, a soluble fiber, a preservative and water, the soluble fiber comprising about 20 to 60 percent by weight of the concentrate volume with a pH in a range of about 1.2 to about 6.5.

24. The beverage concentrate as recited in claim 23, wherein the preservative is selected from the group consisting of sodium benzoate, potassium sorbate, polylysine, propylene glycol, methylparaben, and mixtures thereof.

25. The beverage concentrate as recited in claim 23, wherein the preservative comprises about 0.01 to about 0.3 percent by weight of the beverage concentrate.

26. The beverage concentrate as recited in any claim 23, wherein the preservative comprises about 0.1 percent by weight of the beverage concentrate.

27. A method of delivering a soluble fiber for a nutritional supplement for persons, comprising the steps of:
(a) providing a beverage concentrate according to any one of claim 1; and
(b) admixing the beverage concentrate with water to a volume in a range of about 6 ounces to about 20 ounces.

28. The method as recited in claim 27, wherein the volume is about 8 ounces.

29. The method as recited in claim 27, further comprising the step of pasteurizing of the beverage concentrate.

30. The method as recited in claim 27, further comprising the step of adjusting the pH of the beverage concentrate with a buffering agent to a selected pH in a range of between 1.2 pH and 4.0 pH.

31. The method as recited in claim 27, further comprising the step of adjusting the viscosity of the beverage concentrate to a range between about 25 cp and 75 cp (Brookfield Viscosity (Spindle LV2@30 RPM@25° C.)).

32. The method as recited in claim 27, further comprising the step of mixing as the soluble fiber a first fiber type and a second fiber type.

33. The method as recited in claim 32, wherein the first fiber type comprises corn fiber and the second fiber type comprises dextrose.

34. The method as recited in claim 27, wherein the soluble fiber comprises about 50 per cent by weight of the concentrate volume.

35. The method as recited in claim 27, wherein the soluble fiber comprises about 33 per cent by weight of the concentrate volume.
